(19) United States
(12) Patent Application Publication
(10) Pub. No.: US 2026/0368545 A1
(43) Pub. Date: Nov. 19, 2026

(54) LEARNING APPARATUS, LEARNING METHOD, INFERENCE APPARATUS, INFERENCE METHOD, AND COMPUTER READABLE MEDIUM

(71) Applicant: Mitsubishi Electric Corporation, Tokyo (JP)

(72) Inventor: Hayato UCHIDE, Tokyo (JP)

(73) Assignee: Mitsubishi Electric Corporation, Tokyo (JP)

(21) Appl. No.: 19/733,593

(22) Filed: Jul. 7, 2026

Related U.S. Application Data
(63) Continuation of application No. PCT/JP2024/005756, filed on Feb. 19, 2024.

(51) Int. Cl. G06N 3/096; G06N 3/0455

(52) U.S. Cl. CPC G06N 3/096; G06N 3/0455

(57) ABSTRACT

A filtering unit (22) computes a score of each of a plurality of elements included in teaching source data (311) in first teaching data (31) that includes the teaching source data (311) and teaching destination data (312), using an attention mechanism in a first model (41). The filtering unit (22) filters the plurality of elements included in the teaching source data (311) based on the score of each of the plurality of elements to generate teaching source filtering data (321). A filtering data learning unit (23) learns parameters of a second model (42) that converts the teaching source filtering data (321) to the teaching destination data (312) by taking second teaching data (32) that includes the teaching source filtering data (321) and the teaching destination data (312) as input.

### CROSS REFERENCE TO RELATED APPLICATION

This application is a Continuation of PCT International Application No. PCT/JP2024/005756, filed on Feb. 19, 2024, which is hereby expressly incorporated by reference into the present application.

### TECHNICAL FIELD

The present disclosure relates to technology using a model with an attention mechanism.

### BACKGROUND ART

In sequence-to-sequence tasks such as machine translation using machine learning technology, a neural network model consisting of an encoder and a decoder is used. Hereafter, the neural network model consisting of the encoder and the decoder is referred to as an encoder-decoder model. It is known that introducing an attention mechanism into the encoder-decoder model greatly improvs accuracy. The attention mechanism is, in an example of machine translation, a mechanism that decides, in a data-driven manner, which information of a word in a sentence in the target language is used in the decoder.

A Transformer which is an encoder-decoder model that combines an attention mechanism and a fully connected layer to parallelize an encoder, is currently mainstream. The Transformer is a model consisting of an encoder and a decoder by stacking a combination of a multi-head attention mechanism or a masked multi-head attention mechanism with a fully connected layer.

Hereinafter, the combination of the multi-head attention mechanism or the masked multi-head attention mechanism with the fully connected layer is regarded as one layer, and is referred to as a Transformer layer.

The attention mechanism of the Transformer computes combinations between all elements in an input sequence. If the number of elements in the input sequence is n, the number of combinations among all the elements is n². Therefore, the attention mechanism of the Transformer has a property that causes the usage amount of GPU memory to increase in O(n²). GPU is an abbreviation for Graphics Processing Unit. Accordingly, when the input sequence is long, the computational cost required for processing increases quadratically.

Patent Literature 1 describes a method for generating blocked texts by dividing a long text into topic units, summarizing the text for each block, and generating a summarization result for each topic.

### CITATION LIST

### Patent Literature

Patent Literature 1: JP 2023-034235 A

### SUMMARY OF INVENTION

### Technical Problem

In the technology described in Patent Literature 1, when a blocked text corresponding to a specific topic is long, the required computational cost still increases. When the blocked text is long, it is possible to reduce the computational cost by further dividing the input sequence into small blocks to shorten the input sequence. However, since each blocked text is processed independently, if the text is divided into small blocks, dividing the text into small blocks may result in a loss of context and deteriorate the quality of the generated texts. That is, it is impossible to adjust the length of the input sequence appropriately while maintaining the quality of the generated results.

The purpose of the present disclosure is to enable adjustment of the length of the input sequence appropriately while maintaining the quality of the generated results.

### Solution to Problem

A learning apparatus according to the present disclosure includes:
a filtering unit to compute a score of each of a plurality of elements included in teaching source data in first teaching data that includes the teaching source data which is source sequence data and teaching destination data which is destination sequence data, using an attention mechanism in a first model that infers the destination sequence data from the source sequence data, and to filter the plurality of elements included in the teaching source data based on the score of each of the plurality of elements to generate teaching source filtering data; and
a filtering data learning unit to learn parameters of a second model that converts the teaching source filtering data to the teaching destination data by taking second teaching data that includes the teaching source filtering data generated by the filtering unit and the teaching destination data as input.

### Advantageous Effects of Invention

In the present disclosure, a score is computed for each of a plurality of elements included in source sequence data using the attention mechanism, and the plurality of elements are filtered. Since filtering is done based on scores computed using the attention mechanism, it is possible to adjust the length of the source sequence data which is an input sequence while maintaining the quality of the generated results.

### BRIEF DESCRIPTION OF DRAWINGS

FIG. 1 is a diagram of a hardware configuration of a learning inference apparatus 10 according to Embodiment 1.

FIG. 2 is a diagram of a functional configuration of the learning inference apparatus 10 according to Embodiment 1.

FIG. 3 is an explanatory diagram of an encoder-decoder model that is targeted in Embodiment 1.

FIG. 4 is a flowchart of processes of a learning phase according to Embodiment 1.

FIG. 5 is an explanatory diagram of a filtering process according to Embodiment 1.

FIG. 6 is a flowchart of the filtering process according to Embodiment 1.

FIG. 7 is an explanatory diagram of normal decoding according to Embodiment 1.

FIG. 8 is an explanatory diagram of Teacher Forcing Decoding according to Embodiment 1.

FIG. 9 is an explanatory diagram of a filtering execution process according to Embodiment 1.

FIG. 10 is a flowchart of processes of an inference phase according to Embodiment 1.

FIG. 11 is a diagram of a functional configuration of a learning apparatus 101 according to Modification 1.

FIG. 12 is a diagram of a functional configuration of an inference apparatus 102 according to Modification 1.

FIG. 13 is a diagram of the configuration of the learning inference apparatus 10 according to Embodiment 2.

FIG. 14 is a flowchart of the filtering process according to Embodiment 2.

FIG. 15 is a diagram of the configuration of the learning inference apparatus 10 according to Embodiment 3.

FIG. 16 is a flowchart of the filtering process according to Embodiment 3.

FIG. 17 is an explanatory diagram of a score adjustment process according to Embodiment 3.

FIG. 18 is an explanatory diagram of a filtering data learning process according to Embodiment 4

FIG. 19 is a diagram of the configuration of the learning inference apparatus 10 according to Embodiment 6.

FIG. 20 is a flowchart of the filtering process according to Embodiment 6.

FIG. 21 is an explanatory diagram of the filtering process according to Embodiment 6.

FIG. 22 is a flowchart of the filtering process according to Embodiment 7.

FIG. 23 is an explanatory diagram of the filtering process according to Embodiment 7.

FIG. 24 is a diagram of the configuration of the learning inference apparatus 10 according to Embodiment 8.

FIG. 25 is a flowchart of the filtering process according to Embodiment 8.

FIG. 26 is an explanatory diagram of the filtering execution process according to Embodiment 8.

FIG. 27 is an explanatory diagram of a filtering correction process according to Embodiment 8.

### DESCRIPTION OF EMBODIMENTS

### Embodiment 1

### Description of Configuration

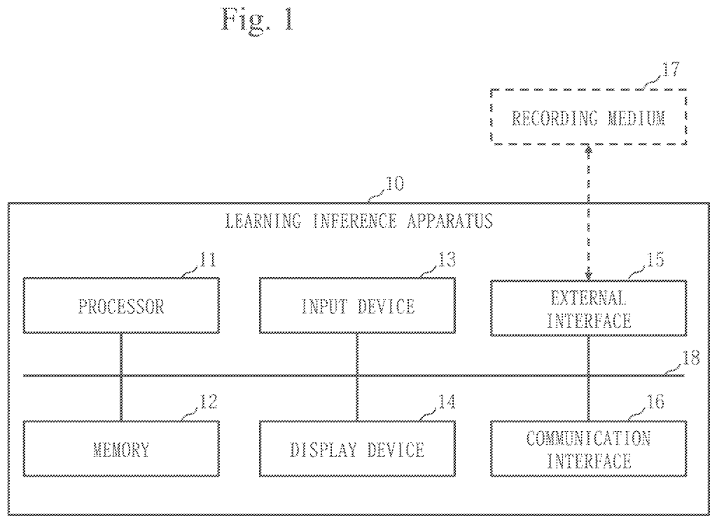

A hardware configuration of a learning inference apparatus 10 according to Embodiment 1 will be described with reference to FIG. 1.

The learning inference apparatus 10 is a computer.

The learning inference apparatus 10 includes pieces of hardware such as a processor 11, a memory 12, an input device 13, a display device 14, an external interface 15, and a communication interface 16. The processor 11 is connected to other pieces of hardware through signal lines and controls these other pieces of hardware.

The processor 11 is an IC that performs processing. IC is an abbreviation for Integrated Circuit. The processor 11 is, as a specific example, a CPU, a DSP, or a GPU. CPU is an abbreviation for Central Processing Unit. DSP is an abbreviation for Digital Signal Processor. GPU is an abbreviation for Graphics Processing Unit.

The memory 12 is a storage device that stores data. The memory 12 is, as a specific example, an HDD, an SSD, a RAM, or a ROM. HDD is an abbreviation for Hard Disk Drive. SSD is an abbreviation for Solid State Drive. RAM is an abbreviation for Random Access Memory. ROM is an abbreviation for Read Only Memory.

The input device 13 is a device for inputting information. The input device 13 is, as a specific example, a keyboard, a mouse, or a touch panel. The display device 14 is a device for displaying information. The display device 14 is, as a specific example, an LCD. LCD is an abbreviation for Liquid Crystal Display.

The learning inference apparatus 10 may not necessarily include at least one of the input device 13 and the display device 14.

The external interface 15 is an interface with an external device such as a recording medium 17. The recording medium 17 is a device that stores data. The processor 11 is capable of reading data stored in the recording medium 17 and writing data to the recording medium 17 via the external interface 15.

The recording medium 17 may also be, as a specific example, a portable recording medium such as an SD (registered trademark) memory card, CompactFlash (registered trademark), NAND flash, a flexible disk, an optical disc, a compact disc, a Blu-ray (registered trademark) disc, a DVD. SD is an abbreviation for Secure Digital. DVD is an abbreviation for Digital Versatile Disk.

The communication interface 16 is an interface for connecting to a communication network. The communication interface 14 is, as a specific example, a port of Ethernet (registered trademark).

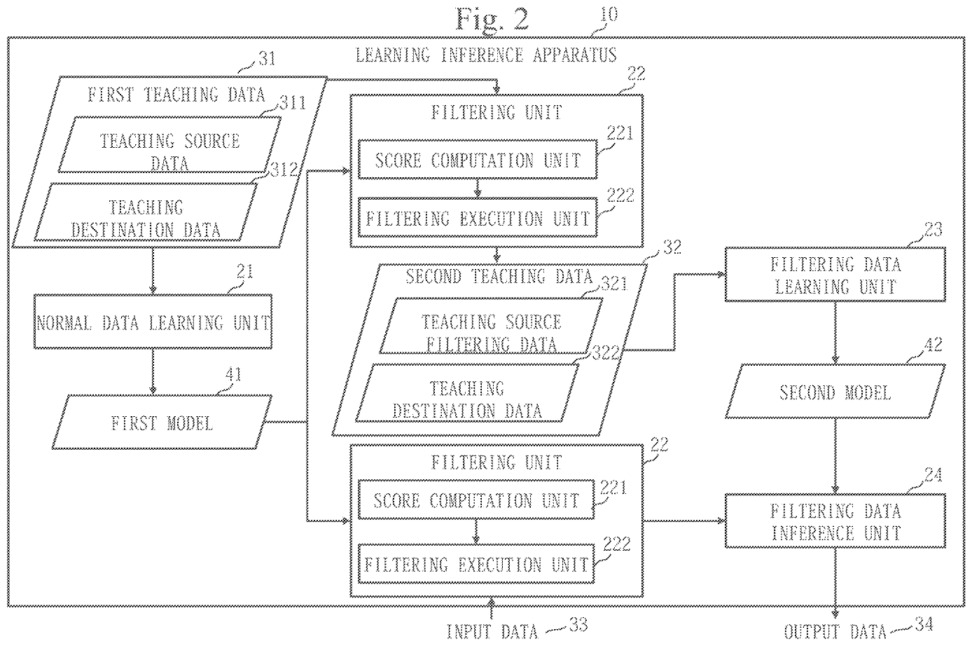

A functional configuration of the learning inference apparatus 10 according to Embodiment 1 will be described with reference to FIG. 2.

The learning inference apparatus 10 includes, as functional components, a normal data learning unit 21, a filtering unit 22, a filtering data learning unit 23, and a filtering data inference unit 24. The filtering unit 22 includes a score computation unit 221 and a filtering execution unit 222. Functions of the individual functional components of the learning inference apparatus 10 are implemented by software.

The memory 12 stores a program that implements the functions of the individual functional components of the learning inference apparatus 10. This program is loaded by the processor 11 and executed by the processor 11. Thus, the functions of the individual functional components of the learning inference apparatus 10 are implemented.

The program that implements the functions of the individual functional component of the learning inference apparatus 10 may also be stored in the recording medium 17. In this case, the processor 11 loads the program from the recording medium 17 via the external interface 15, and executes the program. Further, the program that implements the functions of the individual functional components of the learning inference apparatus 10 may also be stored in an external server or the like. In this case, the processor 11 loads the program from the server or the like via the communication interface 16, and executes the program.

The memory 12 stores pieces of data such as first teaching data 31, second teaching data 32, a first model 41, and a second model 42. These pieces of data may not necessarily be stored in the memory 12, but may also be stored on the recording medium 17, or an external server or the like.

FIG. 1 illustrates only one processor 11. However, there may be a plurality of processors 11, and the plurality of the processors 11 may execute the program that implements each function in cooperation.

### Description of Operation

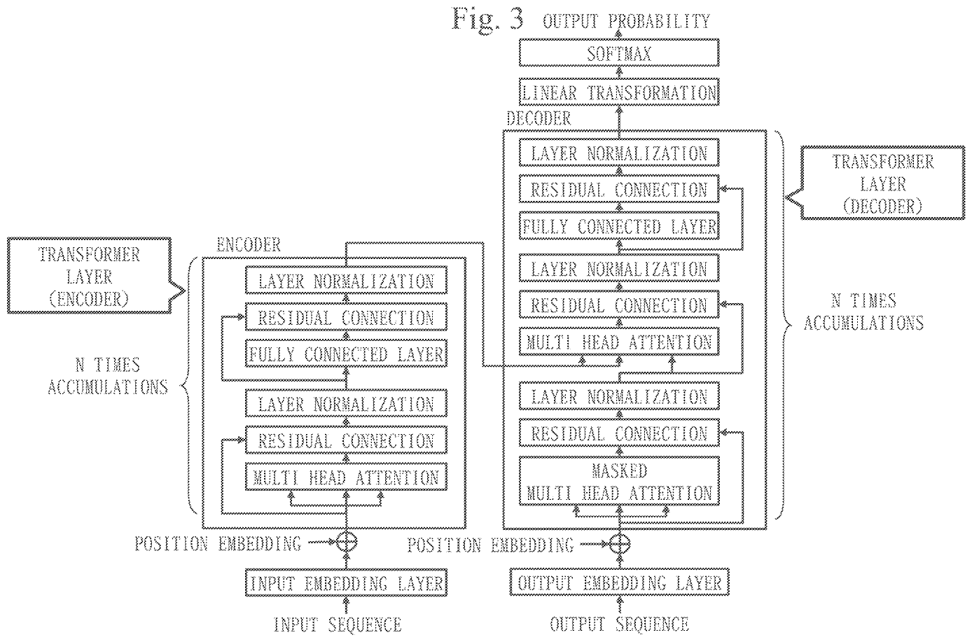

Operation of the learning inference apparatus 10 according to Embodiment 1 will be described with reference to FIGS. 3 to 10.

The operation of the learning inference apparatus 10 includes a learning phase and an inference phase.

An operation procedure of the learning phase of the learning inference apparatus 10 according to Embodiment 1 is equivalent to a learning method according to Embodiment 1. Further, a program that implements the operation of the learning phase of the learning inference apparatus 10 according to Embodiment 1 is equivalent to a learning program according to Embodiment 1.

An operation procedure of the inference phase of the learning inference apparatus 10 according to Embodiment 1 is equivalent to an inference method according to Embodiment 1. Further, a program that implements the operation of the inference phase of the learning inference apparatus 10 according to Embodiment 1 is equivalent to an inference program according to Embodiment 1.

An encoder-decoder model that is targeted in Embodiment 1 will be described with reference to FIG. 3.

The encoder-decoder model that is targeted in Embodiment 1 is a Transformer which is an encoder-decoder model that combines an attention mechanism and a fully connected layer to parallelize an encoder. The Transformer consists of an encoder and a decoder by stacking a combination of a multi-head attention mechanism or a masked multi-head attention mechanism with a fully connected layer.

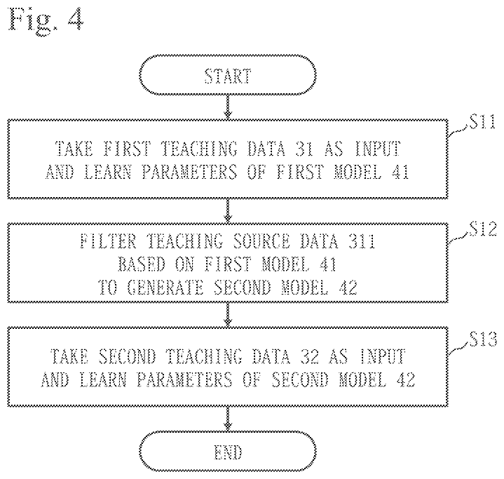

Processing of the learning phase according to Embodiment 1 will be described with reference to FIG. 4.

### Step S11: Normal Data Learning Process

The normal data learning unit 21 takes the first teaching data 31 as input and learns parameters of the first model 41.

The first model 41 is an encoder-decoder model that infers destination sequence data from source sequence data. Here, the first model 41 is a Transformer. Since the first model 41 is the Transformer, the first model 41 has an attention mechanism. The parameters of the first model 41 subject to learning are parameters of the encoder-decoder model subject to learning.

The first teaching data 31 is any sequence data that the encoder-decoder model can input and output. The first teaching data 31 has a data structure that includes teaching source data 311 which is the source sequence data, and teaching destination data 312 which is the destination sequence data.

The first teaching data 31 is, for example, data for machine translation. In this case, the teaching source data 311 which is the source sequence data, is a sequence of words in a translation source language. The sequence of words is a sentence or a phrase. The teaching destination data 312 which is sequence data after conversion is a translation result of the translation source language into a translation destination language. That is, the teaching destination data 312 is a sequence of words in the translation destination language that represents the same meaning as the sequence of words in the translation source language.

### Step S12: Filtering Process

The filtering unit 22 filters the teaching source data 311 included in the first teaching data 31 using the parameters of the first model 41 obtained through learning in step S11. To filter the teaching source data 311 means to remove some of a plurality of elements included in the teaching source data 311. When the first teaching data 31 is data for machine translation, the plurality of elements included in the teaching source data 311 refer to a plurality of words that make up the teaching source data 311. Thus, the filtering unit 22 generates teaching source filtering data 321 in which some elements has been removed from the teaching source data 311.

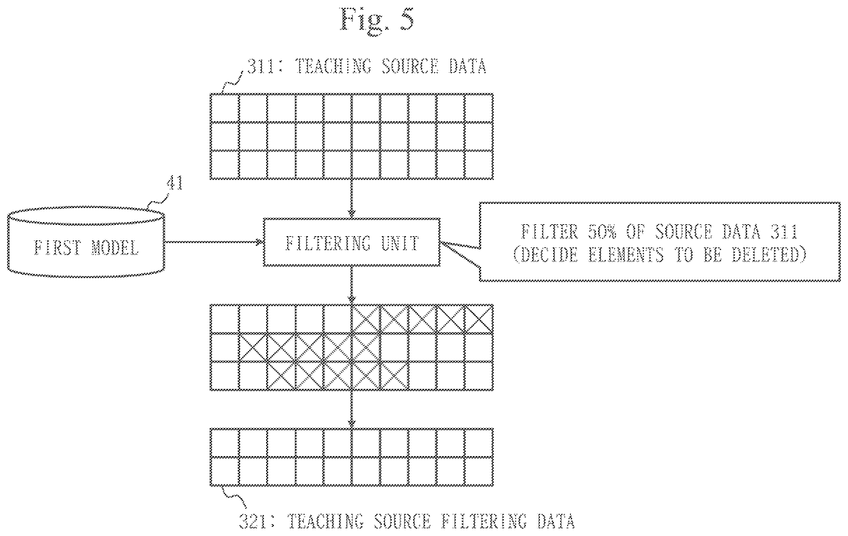

It is assumed that each square illustrated in FIG. 5 is an element included in the teaching source data 311. The filtering unit 22 removes some elements that are marked with X from among the elements included in the teaching source data 311. Thus, the filtering unit 22 generates the teaching source filtering data 321 from the teaching source data 311. In FIG. 5, 50% of the elements included in the teaching source data 311 are removed, and the teaching source filtering data 321 is generated.

Then, the filtering unit 22 generates the second teaching data 32 that includes the teaching source filtering data 321 and the teaching destination data 312.

### Step S13: Filtering Data Learning Process

The filtering data learning unit 23 takes the second teaching data 32 generated in step S12 as input and learns parameters of the second model 42.

The second model 42 is an encoder-decoder model that infers destination sequence data from source sequence data. Here, the second model 42 is a Transformer. The parameters of the second model 42 subject to learning are parameters of the encoder-decoder model subject to learning. Any optimization method may be used as an optimization method used for learning parameters. Adam may be considered to be used as the optimization method, for example. Adam is an abbreviation for ADAptive Moment.

The filtering data learning unit 23 writes the parameters of the second model 42 obtained through learning into the memory 12. Alternatively, the filtering data learning unit 23 may output the parameters to the recording medium 17, an external server, or the display device 14.

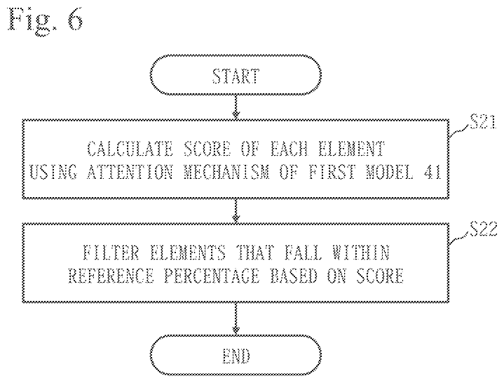

The filtering process according to Embodiment 1 (step S12 of FIG. 4) will be described with reference to FIG. 6.

### Step S21: Score Computation Process

The score computation unit 221 computes a score of each of the plurality of elements included in the teaching source data 311 using the attention mechanism of the first model 41.

Specifically, the score computation unit 221 computes the score of each of the plurality of elements using Attention_{d}, ₗ, ₕ, ᵢ which is the attention mechanism of the first model 41. Attention is Cross-Attention computed in the multi-head attention mechanism of the decoder. That is, the score computation unit 221 computes Attention for each of a plurality of elements in an input sequence of the encoder when an output sequence of the decoder is generated, as the score. In other words, the score computation unit 221 computes an internal state of the first model 41 for each of the plurality of elements in the input sequence of the encoder, as the score. Here, the input sequence of the encoder is the teaching source data 311.

Each of d, l, h, i in Attention_{d}, ₗ, ₕ, ᵢ represents the following. d represents the number of elements in the output sequence of the decoder. l represents the number of layers in a Transformer layer. h represents the number of heads of the multi-head attention mechanism. i represents the number of elements in the input sequence of the encoder.

The score computation unit 221 computes a score Sᵢ for an element i by computing for each i, a maximum value of Attention_{d}, ₗ, ₕ, ᵢ for d, l, h. That is, Sᵢ=MaxAttention(i)=max_{d}, ₗ, ₕ(Attention_{d}, ₗ, ₕ, ᵢ).

Here, although the score computation unit 221 is described as computing the maximum value of Attention_{d}, ₗ, ₕ, ᵢ, the score computation unit 221 may also computes a statistical value other than the maximum value. Further, although the score computation unit 221 may compute the score using all d, l, h, the score computation unit 221 may also compute the score using only certain d, l, h. Further, the score computation unit 221 may obtain a plurality of scores by generating output sequences of a plurality of decoders using general decoding such as beam search, and may extract the maximum value from the plurality of scores and use the extracted value as the final score. Instead of extracting the maximum value, a score obtained by extracting from the plurality of scores by another method may be used as the final score.

Further, the score computation unit 221 may separately prepare a sequence labeling model that uses the score as a teaching signal, and may estimate the score of each of the plurality of elements in the input sequence of the encoder using the sequence labeling mode.

In the above description, Attention has been defined as Cross-Attention computed by the multi-head attention mechanism of the decoder. However, Attention may be Self-Attention computed by the multi-head attention mechanism of the encoder. Further, Attention may be a combination of Cross-Attention and Self-Attention. By computing a sum or a mean value of Cross-Attention and Self-Attention, Cross-Attention and Self-Attention can be combined.

When computing Attention, the score computation unit 221 may use Teacher Forcing Decoding if the score computation unit 221 can use a target output sequence. When computing Attention, the score computation unit 221 may use normal decoding if the score computation unit 221 cannot use the target output sequence.

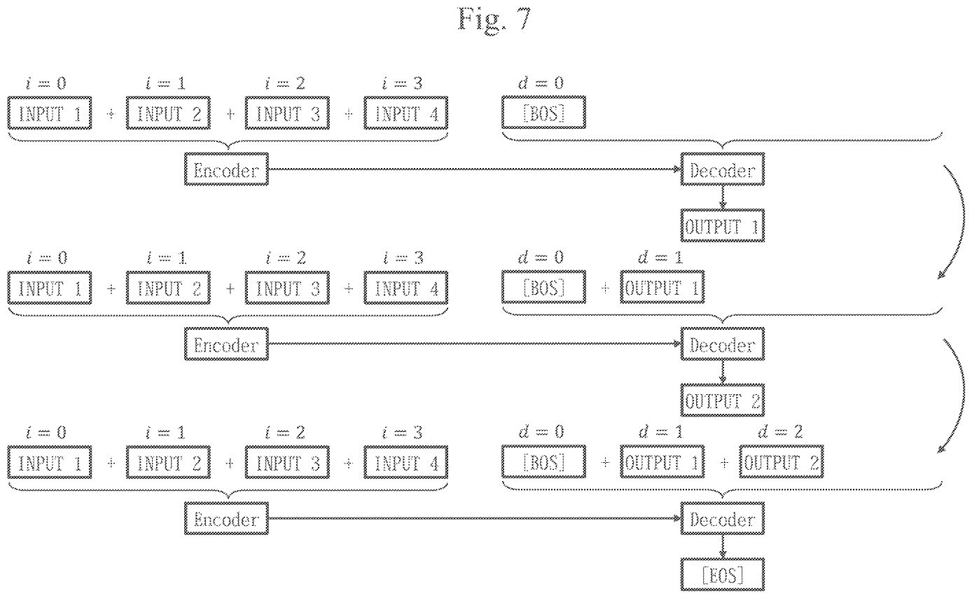

As illustrated in FIG. 7, in the normal decoding, prediction of model is used as the input for the next prediction. The prediction of model is an element that has been previously output by the model.

In FIG. 7, BOS is first given to the decoder, and an output 1 is obtained. BOS is an abbreviation for Begin Of Sentence. Next, BOS and the output 1 are given to the decoder, and an output 2 is obtained. Then, BOS, the output 1, and the output 2 are given to the decoder, and EOS is obtained. EOS is an abbreviation for End Of Sentence.

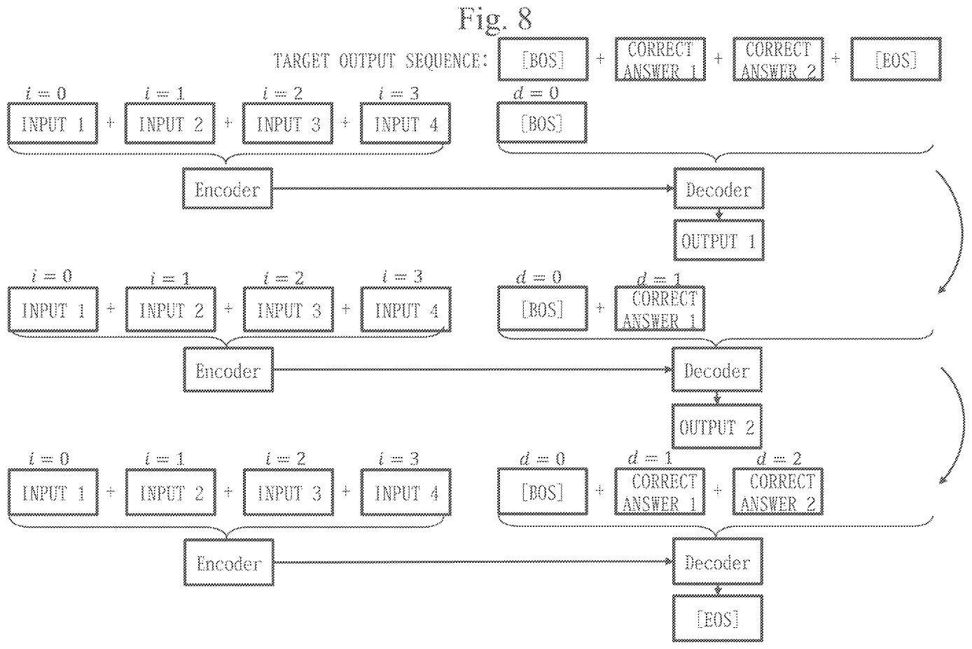

In contrast to this, as illustrated in FIG. 8, Teacher Forcing Decoding provides the target output sequence directly to the model. That is, unlike the normal decoding, Teacher Forcing Decoding does not use a result predicted by the model.

In FIG. 8, BOS+correct answer 1+correct answer 2+EOS is given as the target output sequence. First, BOS is given to the decoder, and an output 1 is obtained. Next, BOS and the correct answer 1 are given to the decoder, and the output 2 is obtained. Then, BOS, the correct answer 1, and the correct answer 2 are given to the decoder, and EOS is obtained.

### Step S22: Filtering Execution Process

The filtering execution unit 222 filters the elements included in the teaching source data 311 based on the score computed in step S21 to generate the teaching source filtering data 321.

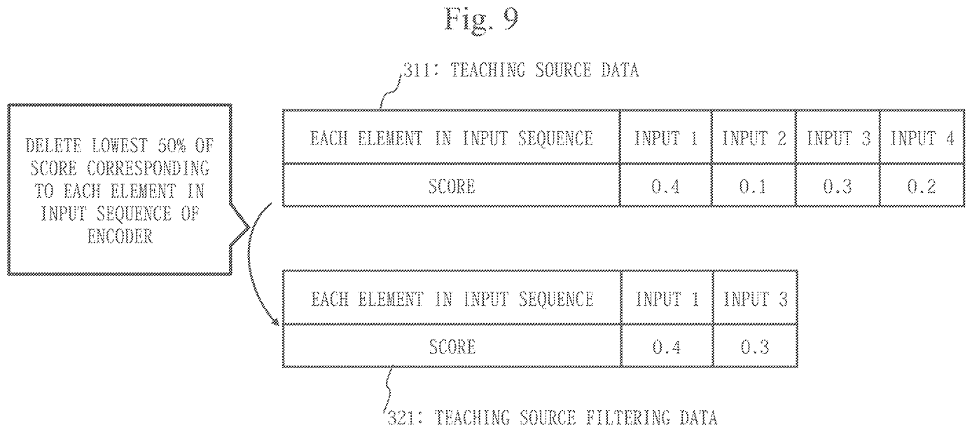

Specifically, as illustrated in FIG. 9, the filtering execution unit 222 generates the teaching source filtering data 321 by removing from the teaching source data 311, elements that start from the lowest score and that fall within a reference percentage. In FIG. 9, four elements are included in the teaching source data 311, and the reference percentage is 50%. Hence, the filtering execution unit 222 generates the teaching source filtering data 321 by removing two elements with the lowest scores from among the four elements. As a result, inputs 2 and 4 with the lowest scores are removed from among inputs 1 to 4 included in the teaching source data 311, and the teaching source filtering data 321 that includes the inputs 1 and 3 is generated.

The filtering execution unit 222 may combine data obtained through filtering by the method described above and data obtained through filtering the teaching source data 311 by another method to generate the teaching source filtering data 321. The filtering by the other method is, as a specific example, to remove from the teaching source data 311, elements that fall within the reference percentage of the highest, lowest or average score ranges, using the maximum value, mean value, median value, or the like. Further, the filtering by the other method is, as another specific example, to remove from the teaching source data 311, elements that fall within the reference percentage of the beginning, end, or middle part of the teaching source data 311.

Further, the filtering execution unit 222 may combine pieces of data obtained through filtering the teaching source data 311 at different percentages to generate the teaching source filtering data 321. The filtering execution unit 222 may combine data obtained by removing 10% from the teaching source data 311, data obtained by removing 30% from the teaching source data 311, and data obtained by removing 50% from the teaching source data 311, to generate the teaching source filtering data 321, for example.

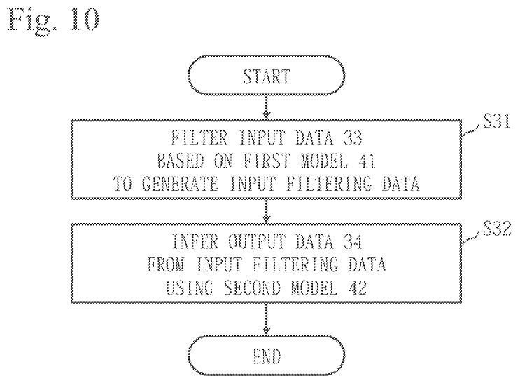

Processes of the inference phase according to Embodiment 1 will be described with reference to FIG. 10.

### Step S31: Filtering Process

The filtering unit 22 filters input data 33 using the parameters of the first model 41 obtained through learning in step S11. The input data 33 is any sequence data that the encoder-decoder model can input and output. Thus, the filtering unit 22 generates input filtering data.

The process of filtering the input data 33 is the same as the process of filtering the teaching source data 311 in step S12 of FIG. 4. That is, the input data 33 is filtered to generate the input filtering data by the same process as the process of filtering the teaching source data 311 to generate the teaching source filtering data 321.

The filtering unit 22 may change the filtering percentage depending on whether the teaching source data 311 is filtered in step S12 of FIG. 4 or the input data 33 is filtered here. When the teaching source data 311 is filtered in step S12 of FIG. 4, the filtering unit 22 filters 50% of the teaching source data 311, and when the input data 33 is filtered here, the filtering unit 22 filters 30% of the input data 33, for example.

### Step S32: Filtering Data Inference Process

The filtering data inference unit 24 infers output data 34 from the input filtering data generated in step S31 using the second model 42. Using the second model 42 means using the parameters of the second model 42 generated in the learning phase.

The filtering data inference unit 24 writes the inferred output data 34 to the memory 12. Alternatively, the filtering data inference unit 24 may output the output data 34 to the recording medium 17, an external server, or the display device 14.

### Effects of Embodiment 1

As described above, the learning inference apparatus 10 according to Embodiment 1 computes the score of each of the plurality of elements included in the source sequence data using the attention mechanism, and filters the plurality of elements. The greater the contribution degree of an element is, the higher the value of its score computed using the attention mechanism will be. Therefore, by performing filtering based on scores computed using the attention mechanism, it is possible to adjust the length of the source sequence data appropriately while maintaining the quality of the generated results. The source sequence data refers to the teaching source data 311 and the input data 33.

Since the length of the source sequence data can be shortened, the computational cost can be lowered. That is, the computational cost of learning the parameters of the second model 42 can be lower than the computational cost of learning the parameters of the first model 41. Further, the computational cost can be lower when the output data 34 is inferred from the input filtering data than when the output data 34 is inferred from the input data 33.

Here, the parameters of the first model 41 are learned with the unfiltered first teaching data 31 as input. Therefore, a high-performance computing environment is necessary because the computational cost is high. On the other hand, the parameters of the second model 42 are learned with the filtered second teaching data 32 as input. Therefore, the high-performance computing environment is unnecessary because the computational cost is low.

There may be a case where a plurality of business tasks or processes using the encoder-decoder model is deployed across a plurality of systems. In this case, it is considered that the high-performance computing environment for the first model 41 is concentrated at one place and a low-performance computing environment for second model 42 is prepared at a deployment destination.

Once the first model 41 has been generated, when the parameters of the second model 42 are learned, the normal data learning process in step S11 of FIG. 4 is unnecessary. That is, once the first model 41 has been generated, when the parameters of second model 42 are learned, step S11 of FIG. 4 may be skipped and the process may proceed from step S12. Therefore, the first model 41 may be prepared in the high-performance computing environment and the parameters of the second model 42 intended for the deployment destination may be learned in the low-performance computing environment at the deployment destination.

### OTHER CONFIGURATIONS

### Modification 1

Embodiment 1 describes an example in which the single learning inference apparatus 10 possesses both the function to perform the learning phase and the function to perform the inference phase. However, the learning inference apparatus 10 may be configured to have only the function to perform the learning phase. The learning inference apparatus 10 which is configured to have only the function to perform the learning phase is referred to as a learning apparatus 101. Further, the learning inference apparatus 10 may be configured to have only the function to perform the inference phase. The learning inference apparatus 10 which is configured to have only the function to perform the inference phase is referred to as an inference apparatus 102.

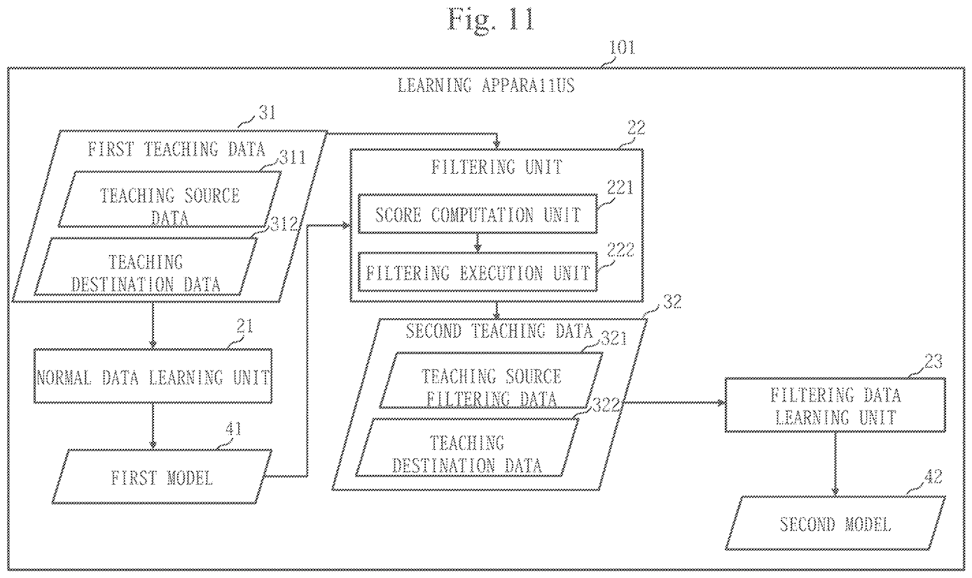

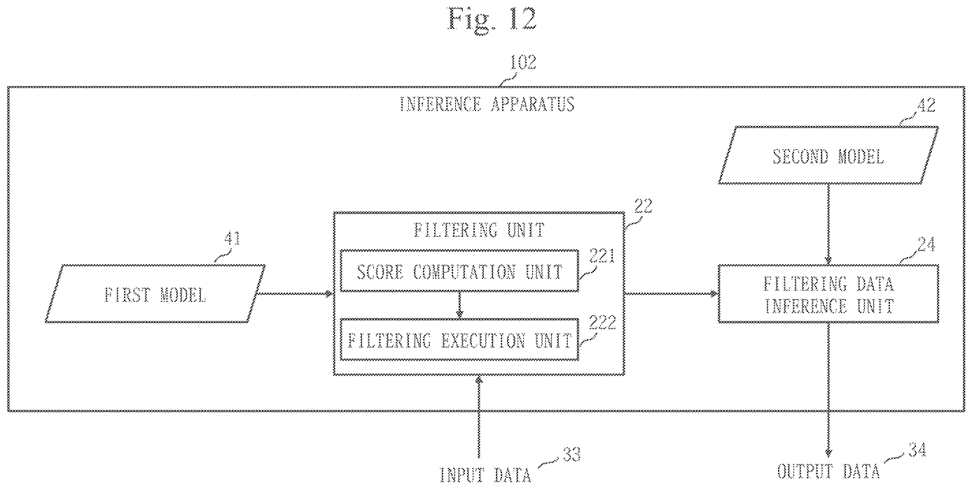

Specifically, the learning apparatus 101 includes, as illustrated in FIG. 11, the normal data learning unit 21, the filtering unit 22, and the filtering data learning unit 23 among the functional components included in the learning inference apparatus 10, without including the filtering data inference unit 24. Further, the inference apparatus 102 includes, as illustrated in FIG. 12, the filtering unit 22 and the filtering data inference unit 24 among the functional components included in the learning inference apparatus 10, without including the normal data learning unit 21 and the filtering data learning unit 23.

When the first model 41 can be obtained externally, the learning apparatus 101 may not need to include the normal data learning unit 21.

### Modification 2

In Embodiment 1, it is assumed that the first teaching data 31 is, as a specific example, data for machine translation. However, the first teaching data 31 may not be limited to this, and may be other data as long as the first teaching data 31 is sequence data. Since the second teaching data 32 is data that has been filtered from the teaching source data 311 of the first teaching data 31, the second teaching data 32 is the same type of data as the first teaching data 31. Further, a set of the input data 33 and the output data 34 is also the same type of data as the first teaching data 31.

(Example 1) The first teaching data 31 is data for natural language processing. The teaching source data 311 is a sequence of words in a specific language, which is, for example, a sentence or a phrase. Then, the teaching destination data 312 is a summary result in the specific language, that is, the teaching destination data 312 is a sequence that consists of fewer words than the teaching source data 311, but that retains the essential meaning of the teaching source data 311.

(Example 2) The first teaching data 31 is data for natural language processing. The teaching source data 311 is a sequence of words that means a question. Then, the teaching destination data 312 is a sequence of words that mean an answer to the question.

(Example 3) The first teaching data 31 is data for voice recognition. The teaching source data 311 is a sequence of voice data that represents human oral speech. Then, the teaching destination data 312 is a sequence of phonemes, features or words that represents the content of the speech.

(Example 4) The first teaching data 31 is data for image processing. The teaching source data 311 is an image, that is, a sequence of colors, brightness, and the like included in the image. Then, the teaching destination data 312 is a sequence of texts that describes the image.

(Example 5) The first teaching data 31 is data for anomaly detection. The teaching source data 311 is a sequence of pieces of data obtained by a specific sensor. Then, the teaching destination data 312 is a sequence of texts that represents either normal or anomaly.

(Example 6) The first teaching data 31 is data for anomaly prediction. The teaching source data 311 is a sequence of pieces of data acquired by a specific sensor. Then, the teaching destination data 312 is a sequence of texts that represents the possibility of a future anomaly occurrence.

(Example 7) The first teaching data 31 is data for demand forecasting. The teaching source data 311 is a sequence of pieces of data related to the number of product sales over an arbitrary period. Then, the teaching destination data 312 is a sequence of texts that represents future product demand.

### Modification 3

The encoder-decoder model targeted in Embodiment 1 is assumed to be a Transformer. Examples of Transformers are BERT, GPT, T5, and the like.

BERT is described in the literature: Devlin, J., Chang, M. W., Lee, K., & Toutanova, K. (2018). Bert: Pre-training of deep bidirectional transformers for language understanding. arXiv preprint arXiv:1810.04805.

GPT is described in the literature: Radford, A., Narasimhan, K., Salimans, T., & Sutskever, I. (2018). Improving language understanding by generative pre-training.

T5 is described in the literature: Raffel, C., Shazeer, N., Roberts, A., Lee, K., Narang, S., Matena, M., . . . & Liu, P. J. (2020). Exploring the limits of transfer learning with a unified text-to-text transformer. The Journal of Machine Learning Research, 21 (1), 5485-5551.

### Modification 4

In Embodiment 1, the individual functional components are implemented by software. However, as Modification 4, the individual functional components may also be implemented by hardware. Aspects that differ from Embodiment 1 will be described for the present Modification 4.

When the individual functional components are implemented by hardware, the learning inference apparatus 10 includes an electronic circuit instead of the processor 11 and the memory 12. The electronic circuit is a dedicated circuit that implements the functions of the individual functional components and the memory 12.

A single circuit, a composite circuit, a programmed processor, a parallel-programmed processor, a logic IC, a GA, an ASIC, or an FPGA may be employed as the electronic circuit. GA is an abbreviation for Gate Array. ASIC is an abbreviation for Application Specific Integrated Circuit. FPGA is an abbreviation for Field-Programmable Gate Array.

The individual functional components may be implemented by a single electronic circuit, or may be implemented by a plurality of electronic circuits through distribution.

### Modification 5

As Modification 5, some of the individual functional components may be implemented by hardware, and the rest of the individual functional components may be implemented by software.

The processor 11, the memory 12, and the electronic circuit are referred to as processing circuitry. That is, the functions of the individual functional components are implemented by the processing circuitry.

### Embodiment 2

Embodiment 2 differs from Embodiment 1 in that when the scores are arranged according to the order of the plurality of elements included in the input sequence, the filtering method is adjusted so that an element that is close to an element whose amount of change in the score is significant becomes difficult to be removed. In Embodiment 2, this difference will be described, and description of the same aspects will be omitted.

### Description of Configuration

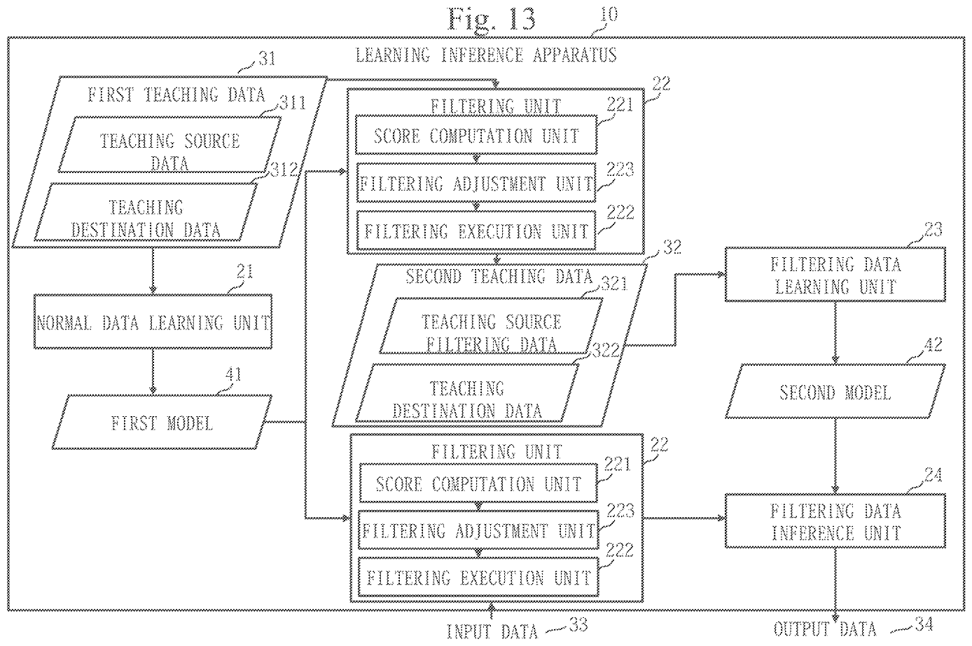

The configuration of the learning inference apparatus 10 according to Embodiment 2 will be described with reference to FIG. 13.

The learning inference apparatus 10 differs from the learning inference apparatus 10 illustrated in FIG. 2 in that the learning inference apparatus 10 includes a filtering adjustment unit 223 as a functional component. A function of the filtering adjustment unit 223 is implemented by software or hardware, as with the other functional components.

### Description of Operation

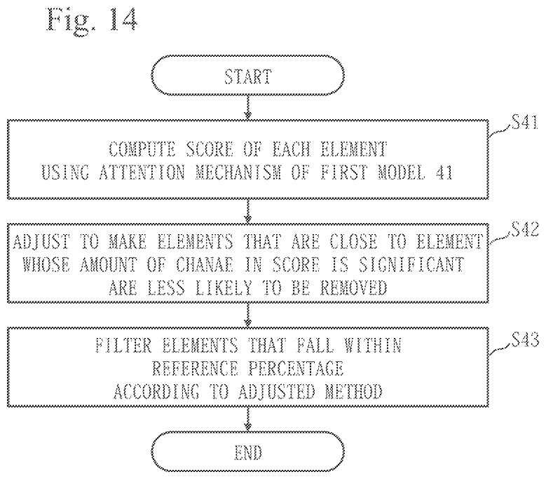

The filtering process according to Embodiment 2 will be described with reference to FIG. 14.

Here, the filtering process in step S12 of FIG. 4 will be described. However, the same applies to the filtering process in step S31 of FIG. 10. A difference is that although the teaching source data 311 is filtered to generate the teaching source filtering data 321 in step S12 of FIG. 4, the input data 33 is filtered to generate the input filtering data in step S31 of FIG. 10.

The process in step S41 is the same as the process in step S21 of FIG. 6.

### Step S42: Filtering Adjustment Process

When the filtering adjustment unit 223 arranges the scores computed in step S41 in the order of the plurality of elements included in the teaching source data 311, the filtering adjustment unit 223 adjusts the filtering method so that an element that is close to an element whose amount of change in the score is significant becomes difficult to be removed. That is, the filtering adjustment unit 223 adjusts the filtering method so that elements that are prior to and subsequent to the element whose amount of change in the score is steep becomes difficult to be removed.

Specifically, the filtering adjustment unit 223 adjusts the filtering method so that elements within a wide range that is almost close to the elements that are prior to and subsequent to the element whose amount of change in the score is significant remain without being removed. The filtering adjustment unit 223 computes moving averages of the scores of the individual elements, for example. At this time, the filtering adjustment unit 223 widens a range for computing the moving averages to include the range that is almost close to the elements that are prior to and subsequent to the element whose amount of change in the score is significant. Then, the filtering adjustment unit 223 causes the filtering execution unit 222 to filter the elements according to values of the moving averages. Thus, the filtering adjustment unit 223 smoothes the values used for filtering according to the amount of change in the score. As a result, an element that is close to the element whose amount of change in the score is significant becomes difficult to be removed.

The filtering adjustment unit 223 may specify the magnitude of the amount of change in the score by computing a value used for detecting a change point such as a derivative value that indicates the amount of change in value.

The filtering adjustment unit 223 may adjust the filtering method so that an element that is close to an element whose score sharply increases becomes difficult to be removed. That is, there is no need for the filtering adjustment unit 223 to adjust the filtering method so that an element that is close to an element whose score sharply decreases becomes difficult to be removed.

### Step S43: Filtering Execution Process

The filtering execution unit 222 executes filtering according to the filtering method adjusted in step S42.

As described in step S42, when the moving average of the score of each element is computed, the filtering execution unit 222 removes elements that start from the lowest moving average and that fall within the reference percentage to generate the teaching source filtering data 321, for example.

### Effects of Embodiment 2

As described above, the learning inference apparatus 10 according to Embodiment 2 adjusts the filtering method so that an element that is close to an element whose amount of change in the score is significant becomes difficult to be removed.

If elements that are close to the element whose amount of change in the score is significant are removed, elements that are prior to and subsequent to the element whose score is high may be deleted, which may result in an unnecessary loss of context. Since the learning inference apparatus 10 according to Embodiment 2 is capable of preventing the elements that are prior to and subsequent to the element whose score is high from being deleted, it is possible to prevent an unnecessary loss of context. Thus, the quality deterioration of the generated results can be prevented.

### Embodiment 3

Embodiment 3 differs from Embodiments 1 and 2 in that Embodiment 3 adjusts a score by weighting the score based on another piece of information that differs from the score itself. In Embodiment 3, this difference will be described, and the description of the same aspects will be omitted.

In Embodiment 3, a case where a function is added to Embodiment 1 will be described. However, the function can also be added to Embodiment 2.

### Description of Configuration

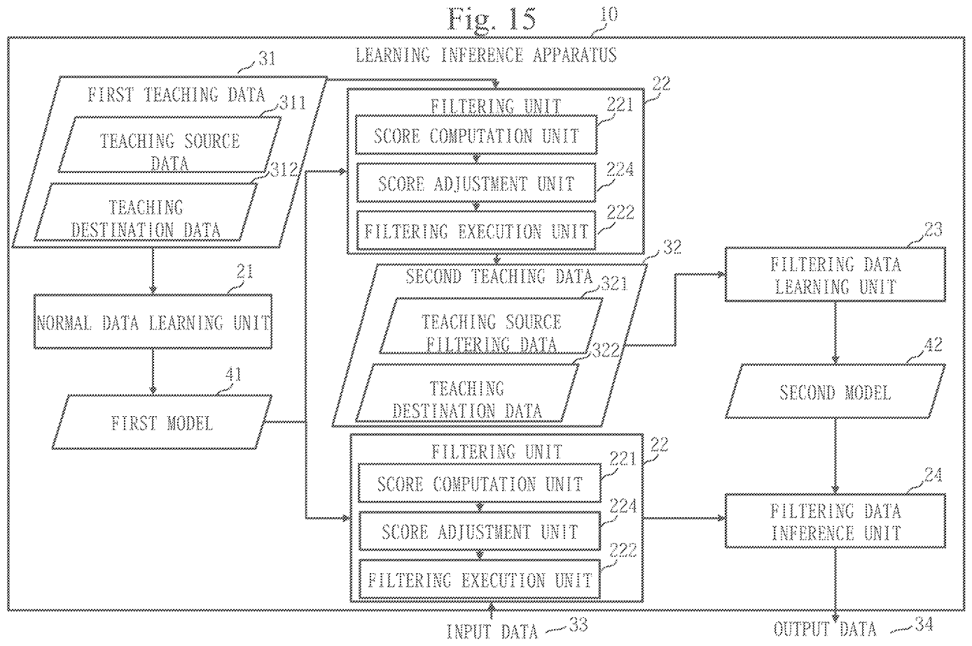

The configuration of the learning inference apparatus 10 according to Embodiment 3 will be described with reference to FIG. 15.

The learning inference apparatus 10 differs from the learning inference apparatus 10 illustrated in FIG. 2 in that the learning inference apparatus 10 includes a score adjustment unit 224 as a functional component. A function of the score adjustment unit 224 is implemented by software or hardware, as with the other functional components.

### Description of Operation

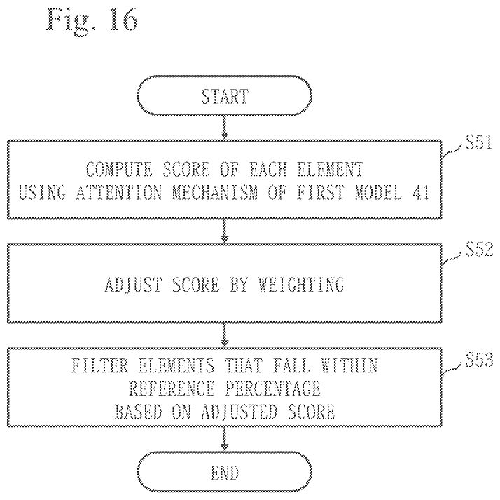

The filtering process according to Embodiment 3 will be described with reference to FIG. 16.

Here, the filtering process in step S12 of FIG. 4 will be described. However, the same applies to the filtering process in step S31 of FIG. 10. A difference is that although the teaching source data 311 is filtered to generate the teaching source filtering data 321 in step S12 of FIG. 4, the input data 33 is filtered to generate the input filtering data in step S31 of FIG. 10.

The process in step S51 is the same as the process in step S21 of FIG. 6.

### Step S52: Score Adjustment Process

The score adjustment unit 224 adjusts the score computed in step S41 by weighting the score based on another piece of information that differs from the score itself.

The other piece of information is, for example, weight information for each element defined by a user. The other piece of information may also be statistical information such as TF-IDF. TF-IDF is an abbreviation for Term Frequency-Inverse Document Frequency.

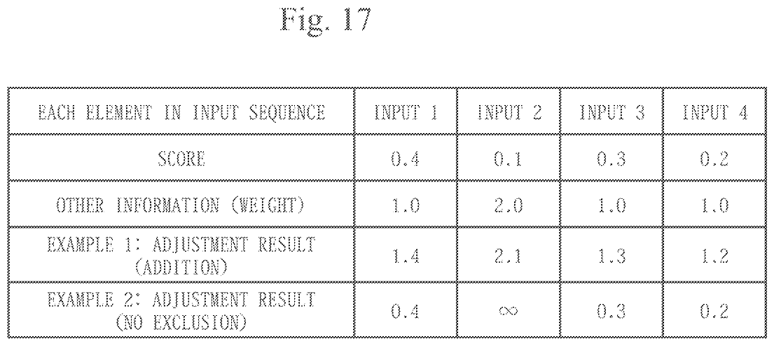

As illustrated in Example 1 of FIG. 17, the score adjustment unit 224 performs weighing by basic operation such as addition or multiplication using the other piece of information that differs from the score itself, to adjust the score. In Example 1 of FIG. 17, the score is adjusted by adding the weight which is the other piece of information that differs from the score itself. Further, as illustrated in Example 2 of FIG. 17, the score adjustment unit 224 may adjust the score to prevent an element that has been given the weight that exceeds a threshold value from being filtered, regardless of its score. In Example 2 of FIG. 17, a value of infinity ∞ is set to the score of the element whose weight which is the other piece of information exceeds the threshold value of 2.0 to prevent the element from being filtered.

### Step S53: Filtering Execution Process

The filtering execution unit 222 performs filtering based on the score adjusted in step S52.

### Effects of Embodiment 3

As described above, the learning inference apparatus 10 according to Embodiment 3 adjusts a score by weighing the score based on another piece of information that differs from the score itself. Thus, an unintentional loss of context that occurs solely from the score of each element in the input sequence can be prevented. As a result, the quality deterioration of the generated results can be prevented.

### Embodiment 4

Embodiment 4 differs from Embodiments 1 to 3 in that Embodiment 4 stably learns a model through curriculum learning in which the percentage of elements to be filtered serves as a measure of the difficulty level. In Embodiment 4, this difference will be described, and the description of the same aspects will be omitted.

In Embodiment 4, a case where a function is added to Embodiment 1 will be described. However, the function may be added to Embodiment 2 or 3.

### Description of Operation

The process of the learning phase according to Embodiment 4 will be described with reference to FIG. 4.

The process of step S11 is the same as that in Embodiment 1.

### Step S12: Filtering Process

The filtering unit 22 filters the teaching source data 311 included in the first teaching data 31 using the parameters of the first model 41 obtained through learning of step S11.

At this time, the filtering unit 22 sets each of a plurality of percentages as a target percentage. Then, the filtering unit 22 filters the teaching source data 311 to remove from the elements included in the teaching source data 311, elements that fall within the target percentage to generate the teaching source filtering data 321 corresponding to the target percentage. Then, the filtering unit 22 generates the second teaching data 32 that includes the teaching source filtering data 321 corresponding to the target percentage and the teaching destination data 312.

The filtering unit 22 sets each of 50%, 70%, and 90% as the target percentage, for example. Then, the filtering unit 22 filters the teaching source data 311 to remove from the elements included in the teaching source data 311, 50% of the elements to generate the teaching source filtering data 321 corresponding to 50%. Further, the filtering unit 22 filters the teaching source data 311 to remove from the elements included in the teaching source data 311, 70% of the elements to generate the teaching source filtering data 321 corresponding to 70%. Furthermore, the filtering unit 22 filters the teaching source data 311 to remove from the elements included in the teaching source data 311, 90% of the elements to generate the teaching source filtering data 321 corresponding to 90%.

### Step S13: Filtering Data Learning Process

The filtering data learning unit 23 sets the teaching source filtering data 321 corresponding to each of the plurality of percentages as the target teaching source filtering data 321 in ascending order from the lowest percentage. Then, the filtering data learning unit 23 takes the second teaching data 32 that includes the target teaching source filtering data 321 and the teaching destination data 312 as input, to learn the parameters of the second model 42 that converts the target teaching source filtering data 321 into the teaching destination data 312.

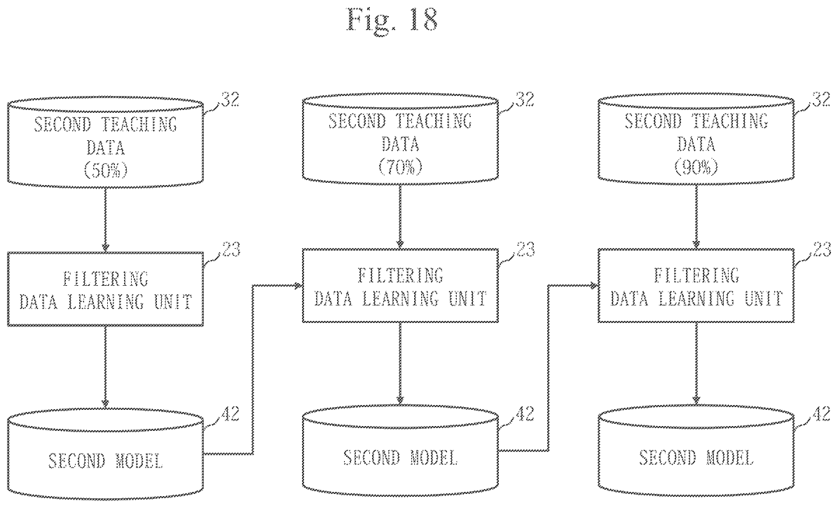

It is assumed that the second teaching data 32 corresponding to 50%, 70%, and 90% is generated, for example. In this case, as illustrated in FIG. 18, first, the filtering data learning unit 23 learns the parameters of the second model 42 using the second teaching data 32 corresponding to 50%. Next, the filtering data learning unit 23 learns the parameters of the second model 42 using the second teaching data 32 corresponding to 70%. Then, the filtering data learning unit 23 learns the parameters of the second model 42 using the second teaching data 32 corresponding to 90%.

The filtering data learning unit 23 uses the parameters of the second model 42 obtained through learning at the previous stage, as initial values of the parameters of the second model 42 during learning. However, the filtering data learning unit 23 may also use the parameters of the second model 42 obtained through learning at two or more previous stages more than two stages, as the initial values of the parameters of the second model 42 during learning.

### Effects of Embodiment 4

As described above, the learning inference apparatus 10 according to Embodiment 4 performs curriculum learning in which the percentage of elements to be filtered serves as a measure of the difficulty level. Thus, it is possible to gradually learn a difference between the filtered data and the teaching source data 311 prior to filtering, and the difference is caused by the filtering. Therefore, it is possible to stably perform learning with the parameters of the second model 42.

### Embodiment 5

Embodiment 5 differs from Embodiments 1 to 4 in that Embodiment 5 learns the parameters of the second model 42 to bring a score obtained from a computation result by the attention mechanism in the first model 41 close to a score obtained from a computation result by the attention mechanism in the second model 42. In Embodiment 5, this difference will be described, and description of the same aspects will be omitted.

In Embodiment 5, a case where a function is added to Embodiment 1 will be described. However, the function can also be added to Embodiments 2 to 4.

### Description of Operation

The process of the learning phase according to Embodiment 5 will be described with reference to FIG. 4.

The processes of steps S11 and S12 are the same as those of Embodiment 1.

### Step S13: Filtering Data Learning Process

The filtering data learning unit 23 learns the parameters of the second model 42 to bring a score obtained from a computation result by the attention mechanism in the first model 41 close to a score obtained from a computation result by the attention mechanism in the second model 42.

Specifically, the filtering data learning unit 23 introduces a difference or a similarity degree between the score obtained from the computation result by the attention mechanism in the first model 41 and the score obtained from the computation result by the attention mechanism in the second model 42 to a loss function used when learning the second model 42. Here, the score obtained from the computation result by the attention mechanism in the first model 41 is the score computed in step S21. That is, the score obtained from the computation result by the attention mechanism in the first model 41 is the score obtained by Attention which is the attention mechanism of the first model 41. The score obtained from the computation result by the attention mechanism in the second model 42 is the score computed by the method described in step S21. That is, the score obtained from the computation result by the attention mechanism in the second model 42 is the score obtained by Attention which is the attention mechanism of the second model 42.

The filtering data learning unit 23 may use a mean squared error MSE between the score of the first model 41 and the score of second model 42 as the loss function, for example. The mean squared error MSE between the score of the first model 41 and the score of second model 42 is represented as equation 1.

MSE=(1/N)Σᵢ₌₁^{N}(Aᵢ−Bᵢ)² (Equation 1)

Here, N represents the number of elements of Attention. A represents Attention of the first model 41. B represents Attention of the second model 42.

Attention here may be Cross-Attention computed by the multi-head attention mechanism of the decoder, or may be Self-Attention computed by the multi-head attention mechanism of the encoder. Further, Attention here may be a combination of Cross-Attention and Self-Attention.

Attention described above is intended to approximate the whole of the first model 41 and the second model 42. However, it is also possible to approximate a specific layer or a specific head.

Further, the mean squared error MSE is used here as the loss function. However, the loss function may use another function such as a cross entropy error or a cosine similarity degree.

### Effects of Embodiment 5

As described above, the learning inference apparatus 10 according to Embodiment 5 learns the parameters of the second model to bring the score of the first model 41 close to the score of the second model 42. Thus, the learning inference apparatus 10 can take not only a result of filtering, but also an internal state of the first model 41 used for filtering as teaching data, to learn the second model 42. Therefore, learning can proceed stably.

### Embodiment 6

Embodiment 6 differs from Embodiments 1 to 5 in that the teaching destination data 312 is generated by merging results obtained through filtering the teaching source data 311 in arbitrary length units. In Embodiment 6, this difference will be described, and the description of the same aspects will be omitted.

In Embodiment 6, a case where a function is added to Embodiment 1 will be described. However, the functions can be added to Embodiments 2 to 5.

### Description of Configuration

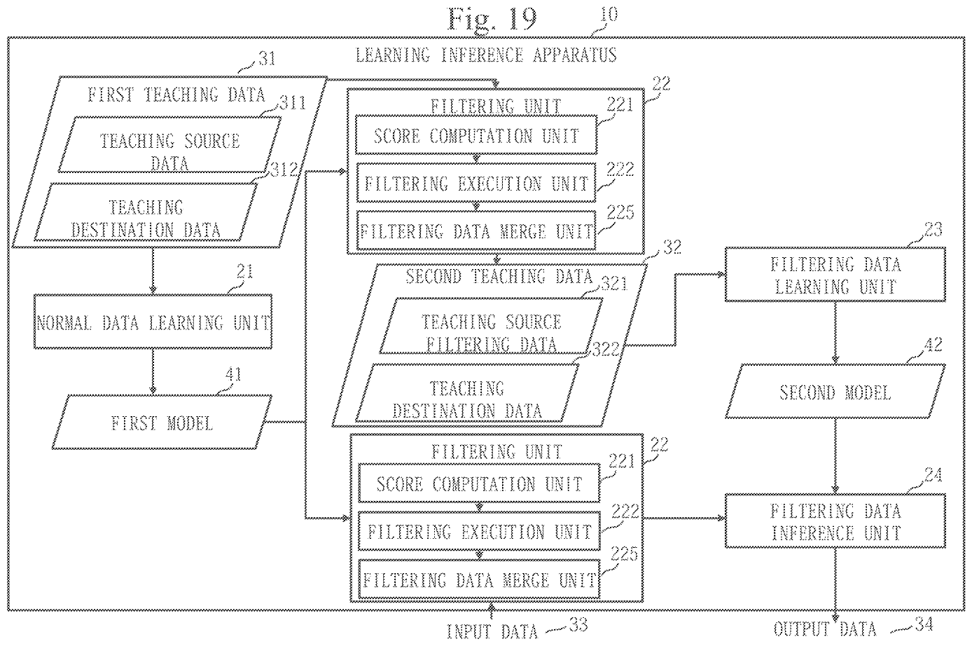

The configuration of the learning inference apparatus 10 according to Embodiment 6 will be described with reference to FIG. 19.

The learning inference apparatus 10 differs from the learning inference apparatus 10 illustrated in FIG. 2 in that the learning inference apparatus 10 includes a filtering data merge unit 225 as a functional component. A function of the filtering data merge unit 225 is implemented by software or hardware, as with the other functional components.

### Description of Operation

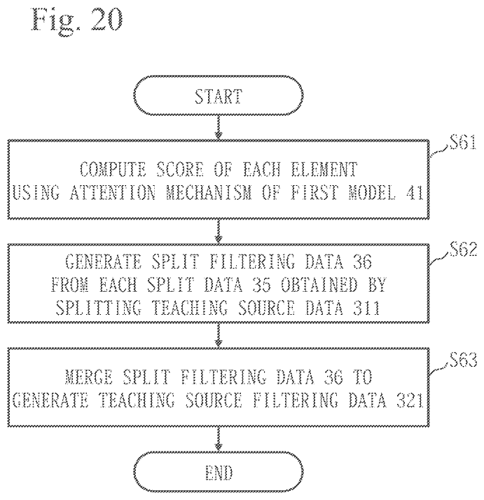

The filtering process according to Embodiment 6 will be described with reference to FIG. 20.

Here, the filtering process in step S12 of FIG. 4 will be described. However, the same applies to the filtering process in step S31 of FIG. 10. A difference is that although the teaching source data 311 is filtered to generate the teaching source filtering data 321 in step S12 of FIG. 4, the input data 33 is filtered to generate input filtering data in step S31 of FIG. 10.

The process in step S61 is the same as the process in step S21 of FIG. 6.

### Step S62: Filtering Execution Process

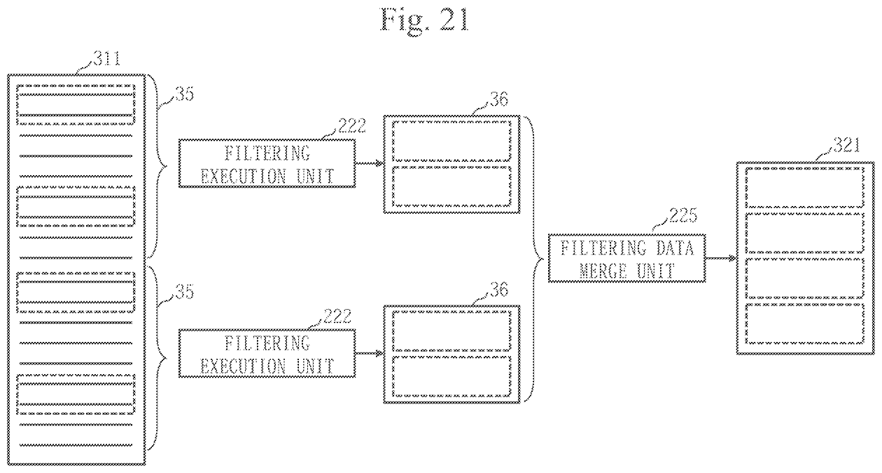

As illustrated in FIG. 21, the filtering execution unit 222 sets each of a plurality of pieces of split data 35 obtained by splitting the teaching source data 311, as target split data 35. The filtering execution unit 222 filters elements included in the target split data 35 to generate split filtering data 36 corresponding to the target split data 35.

In FIG. 21, the filtering execution unit 222 generates two pieces of split data 35 by splitting the teaching source data 311 into two pieces. Then, the filtering execution unit 222 filters each of the two pieces of split data 35 to generate two pieces of split filtering data 36.

The filtering execution unit 222 may split the teaching source data 311 into any length. The filtering execution unit 222 may split the teaching source data 311 into separate topics, for example. Alternatively, the filtering execution unit 222 may split the teaching source data 311 into pieces of a reference length.

### Step S63: Filtering Data Merge Process

As illustrated in FIG. 21, the filtering data merge unit 225 merges the split filtering data 36 corresponding to each of the plurality of pieces of split data 35 generated in step S62 to generate the teaching source filtering data 321.

In FIG. 21, the filtering data merge unit 225 merges the split filtering data 36 corresponding to each of the two pieces of split data 35 to generate the teaching source filtering data 321.

### Effects of Embodiment 6

As described above, the learning inference apparatus 10 according to Embodiment 6 merges results obtained through filtering the teaching source data 311 in arbitrary length units to generate the teaching source filtering data 321. Thus, when the computational cost of filtering becomes high, it is possible to reduce the computational cost of filtering while preventing loss of context.

### Embodiment 7

Embodiment 7 differs from Embodiment 6 in that Embodiment 7 repeatedly performs filtering until a data length is less than or equal to a specified length, and merges pieces of filtered data. In Embodiment 7, this difference will be described, and the description of the same aspects will be omitted.

### Description of Operation

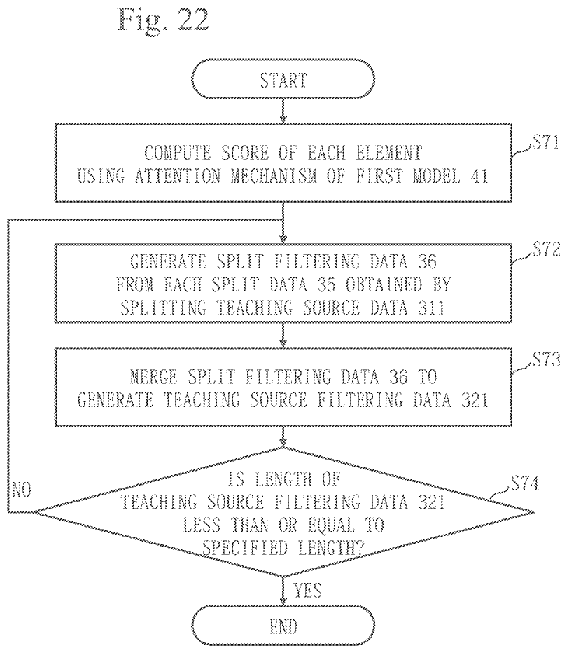

The filtering process according to Embodiment 7 will be described with reference to FIG. 22.

Here, the filtering process in step S12 of FIG. 4 will be described. However, the same applies to the filtering process in step S31 of FIG. 10. A difference is that although the teaching source data 311 is filtered to generate the teaching source filtering data 321 in step S12 of FIG. 4, the input data 33 is filtered to generate input filtering data in step S31 of FIG. 10.

The processes from steps S71 to S73 are the same as the processes from steps S61 to S63 in FIG. 20.

### Step S74: Length Determination Process

The filtering data merge unit 225 determines whether or not the length of the teaching source filtering data 321 generated in step S73 is less than or equal to a specified length.

When the length of the teaching source filtering data 321 is less than or equal to the specified length, the filtering data merge unit 225 ends the process. On the other hand, when the length of the teaching source filtering data 321 is not less than or equal to the specified length, the filtering data merge unit 225 returns the process to step S72.

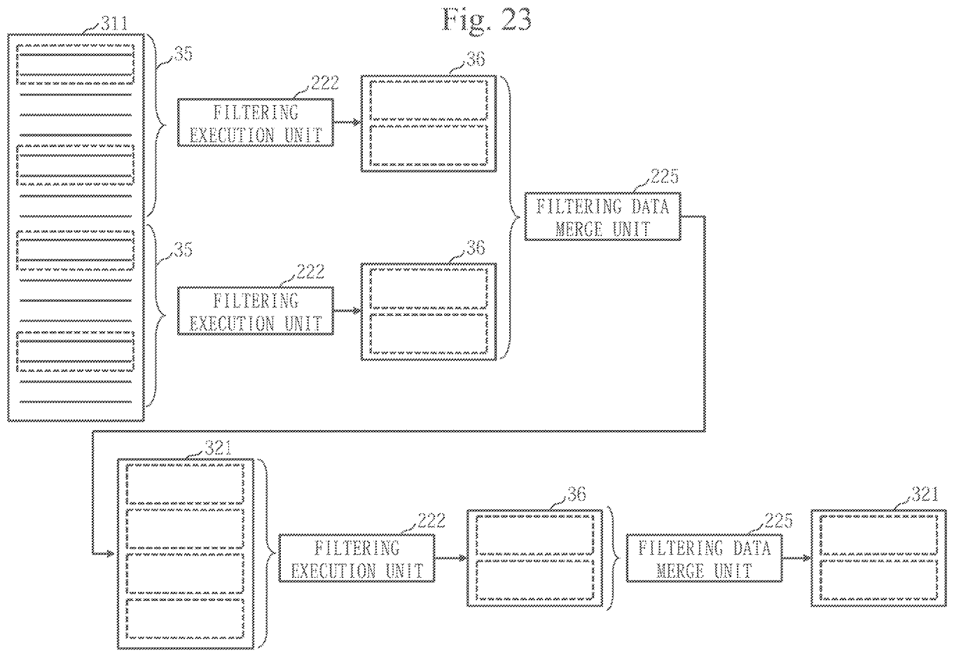

As illustrated in FIG. 23, when the process is returned to step S72, the filtering execution unit 222 sets each of pieces of split data 35 to one or more pieces obtained by splitting the teaching source filtering data 321 generated in step S73, as the target split data 35. The filtering execution unit 222 filters elements included in the target split data 35 to newly generate the split filtering data 36 corresponding to the target split data 35. Then, in step S73, the filtering data merge unit 225 merges the newly generated split filtering data 36 to newly generate the teaching source filtering data 321.

In FIG. 23, the split filtering data 36 is generated for each of two pieces of split data 35 in the first filtering execution process, and the teaching source filtering data 321 is generated. Then, in the second filtering execution process, the split filtering data 36 is newly generated for one piece of split data 35, and the split filtering data 36 is directly set as the teaching source filtering data 321.

### Effects of Embodiment 7

As described above, the learning inference apparatus 10 according to Embodiment 7 repeatedly performs filtering and merges pieces of filtered data until a data length is less than or equal to a specified length. Thus, even when an input sequence is long, it is possible to generate the teaching source filtering data 321 of the intended length while preventing loss of context and minimizing the computational cost of filtering.

### Embodiment 8

Embodiment 8 differs from Embodiments 1 to 7 in that Embodiment 8 assigns a special token to an element that has been removed after filtering. In Embodiment 8, this difference will be described, and the same aspects will be omitted.

In Embodiment 8, a case where a function is added to Embodiment 1 will be described. However, it is also possible to add the function to Embodiments 2 to 7.

### Description of Configuration

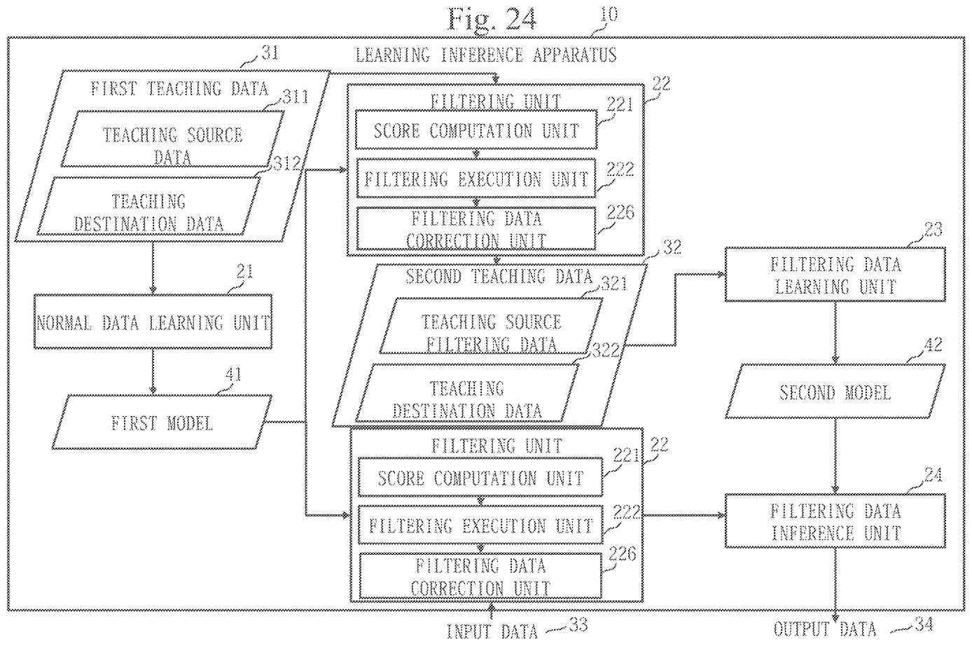

The configuration of the learning inference apparatus 10 according to Embodiment 8 will be described with reference to FIG. 24.

The learning inference apparatus 10 differs from the learning inference apparatus 10 illustrated in FIG. 2 in that the learning inference apparatus 10 includes a filtering correction unit 226 as a functional component. The function of the filtering correction unit 226 is implemented by software or hardware, as with the other functional components.

### Description of Operation

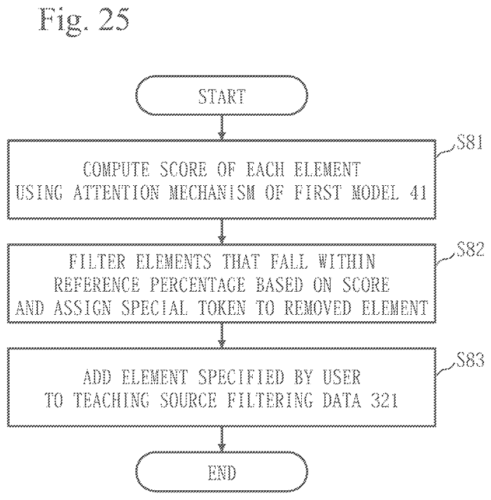

The filtering process according to Embodiment 8 will be described with reference to FIG. 25.

Here, the filtering process in step S12 of FIG. 4 will be described. However, the same applies to the filtering process in step S31 of FIG. 10. A difference is that although the teaching source data 311 is filtered to generate the teaching source filtering data 321 in step S12 of FIG. 4, the input data 33 is filtered to generate the input filtering data in step S31 of FIG. 10.

The process in step S81 is the same as the process in step S21 of FIG. 6.

### Step S82: Filtering Execution Process

The filtering execution unit 222 filters the elements included in the teaching source data 311 based on the score computed in step S21 to generate the teaching source filtering data 321.

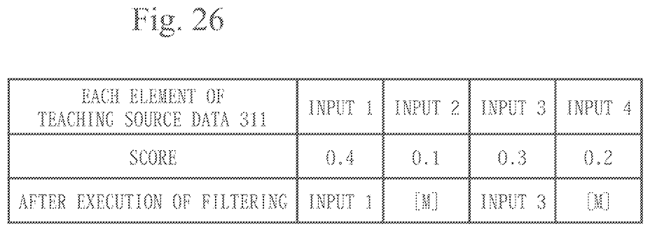

At this time, as illustrated in FIG. 26, the filtering execution unit 222 assigns a special token to elements removed through filtering. In FIG. 26, as in FIG. 9, inputs 2 and 4 are removed, and the teaching source filtering data 321 that includes inputs 1 and 3 is generated. Then, the filtering execution unit 222 assigns a special token [M] to the removed inputs 2 and 4.

### Step S83: Filtering Correction Process

The filtering correction unit 226 outputs results of the filtering performed in step S82 to the display device 14. At this time, the filtering correction unit 226 displays each element of the teaching source data 311 after indicating the special token [M] to the elements removed through the filtering. Thus, a user understands which elements have been removed.

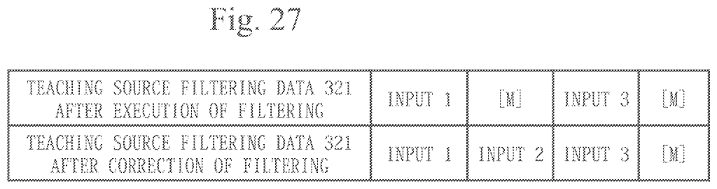

Then, the filtering correction unit 226 accepts a specification of an element that the user considers inappropriate for removal. As illustrated in FIG. 27, the filtering correction unit 226 stops removing the element that is specified as inappropriate for removal and adds the element to the teaching source filtering data 321. In FIG. 27, since the input 2 is specified as inappropriate for removal, the input 2 is added to the teaching source filtering data 321.

### Effects of Embodiment 8

As described above, the learning inference apparatus 10 according to Embodiment 8 assigns a special token to an element that has been removed after filtering. Thus, the user can easily specify the element that has been removed through the filtering.

Further, the learning inference apparatus 10 according to Embodiment 8 adds an element specified by the user to the teaching source filtering data 321 by the filtering correction unit 226. Thus, the user can correct the filtered results and obtain the desirable teaching source filtering data 321.

The term “unit” in the above description may be replaced with “circuit”, “process”, “procedure”, “processing”, or “processing circuitry”.

The embodiments and modifications of the present disclosure have been described above. Among these embodiments and modifications, some may be practiced by combination. Alternatively, one or some of these embodiments and modifications may be practiced partly. The present disclosure is not limited to the above embodiments and modifications, and various modifications can be made as necessary.

### REFERENCE SIGNS LIST

10: learning inference apparatus; 11: processor; 12: memory; 13: input device; 14: display device; 15: external interface; 16: communication interface; 17: recording medium; 21: normal data learning unit; 22: filtering unit; 221: score computation unit; 222: filtering execution unit; 223: filtering adjustment unit; 224: score adjustment unit; 225: filtering data merge unit; 226: filtering correction unit; 23: filtering data learning unit; 24: filtering data inference unit; 31: first teaching data; 311: teaching source data; 312: teaching destination data; 32: second teaching data; 321: teaching source filtering data; 33: input data; 34: output data; 35: split data; 36: split filtering data; 41: first model; 42: second model; 101: learning apparatus; 102: inference apparatus.

1. A learning apparatus comprising:
processing circuitry:
to compute a score of each of a plurality of elements included in teaching source data in first teaching data that includes the teaching source data which is source sequence data and teaching destination data which is destination sequence data, using an attention mechanism in a first model that infers the destination sequence data from the source sequence data, and to filter the plurality of elements included in the teaching source data based on the score of each of the plurality of elements to generate teaching source filtering data; and
to learn parameters of a second model that converts the teaching source filtering data to the teaching destination data by taking second teaching data that includes the generated teaching source filtering data and the teaching destination data as input, wherein
the processing circuitry sets each of a plurality of pieces of split data obtained by splitting the teaching source data as target split data, and filters elements included in the target split data to generate split filtering data corresponding to the target split data, and
the processing circuitry merges the split filtering data corresponding to each of the plurality of pieces of split data to generate the teaching source filtering data.

2. A learning apparatus comprising:
processing circuitry:
to compute a score of each of a plurality of elements included in teaching source data in first teaching data that includes the teaching source data which is source sequence data and teaching destination data which is destination sequence data, using an attention mechanism in a first model that infers the destination sequence data from the source sequence data, and to filter the plurality of elements included in the teaching source data based on the score of each of the plurality of elements to generate teaching source filtering data; and
to learn parameters of a second model that converts the teaching source filtering data to the teaching destination data by taking second teaching data that includes the generated teaching source filtering data and the teaching destination data as input, wherein
the processing circuitry assigns a special token to an element that has been removed through filtering, and
the processing circuitry restores the specified special token back to an original element.

3. The learning apparatus according to claim 1, wherein
the processing circuitry computes the score of each of the plurality of elements,
the processing circuitry, when the computed scores are arranged according to the order of the plurality of elements included in the teaching source data, adjusts a filtering method so that an element that is close to an element whose amount of change in the score is significant becomes difficult to be removed, and
the processing circuitry performs filtering according to the adjusted filtering method.

4. The learning apparatus according to claim 1, wherein
the processing circuitry computes the score of each of the plurality of elements,
the processing circuitry adjusts the score by weighting the computed score based on another piece of information that differs from the score itself, and
the processing circuitry performs filtering based on the adjusted score.

5. The learning apparatus according to claim 1, wherein
the processing circuitry sets each of a plurality of percentages as a target percentage, performs filtering to remove from the elements included in the teaching source data, elements that fall within the target percentage, and generates the teaching source filtering data corresponding to the target percentage, and
the processing circuitry sets the teaching source filtering data corresponding to each of the plurality of percentages as target teaching source filtering data in ascending order from the lowest percentage, and takes second teaching data that includes the target teaching source filtering data and the teaching destination data as input to learn parameters of a second model that converts the target teaching source filtering data to the teaching destination data.

6. The learning apparatus according to claim 1, wherein
the processing circuitry learns the parameters of the second model to bring a score obtained from a computation result by an attention mechanism in the first model close to a score obtained from a computation result by an attention mechanism in the second model.

7. The learning apparatus according to claim 1, wherein
the processing circuitry, when the teaching source filtering data is longer than a specified length, sets each of one or more pieces of split data obtained by splitting the teaching source filtering data as target split data, and filters elements included in the target split data to newly generate split filtering data corresponding to the target split data, and
the processing circuitry merges the newly generated split filtering data to newly generate the teaching source filtering data.

8. An inference apparatus comprising:
processing circuitry:
to compute a score of each of a plurality of elements included in input data which is source sequence data, using an attention mechanism in a first model that infers destination sequence data from source sequence data, and to filter the plurality of elements included in the input data based on the score of each of the plurality of elements to generate input filtering data; and
to infer output data from the generated input filtering data using a second model that infers destination sequence data from source sequence data, wherein
the processing circuitry sets each of a plurality of pieces of split data obtained by splitting the input data as target split data, and filters elements included in the target split data to generate split filtering data corresponding to the target split data, and
the processing circuitry merges the split filtering data corresponding to each of the plurality of pieces of split data to generate the input filtering data.

9. An inference apparatus comprising:
processing circuitry:
to compute a score of each of a plurality of elements included in input data which is source sequence data, using an attention mechanism in a first model that infers destination sequence data from source sequence data, and to filter the plurality of elements included in the input data based on the score of each of the plurality of elements to generate input filtering data; and
to infer output data from the generated input filtering data using a second model that infers destination sequence data from source sequence data, wherein
the processing circuitry assigns a special token to an element that has been removed through filtering, and
the processing circuitry restores the specified special token back to an original element.

10. The inference apparatus according to claim 8, wherein
the processing circuitry computes the score of each of the plurality of elements,
the processing circuitry, when the computed scores are arranged according to the order of the plurality of elements included in the input data, adjusts a filtering method so that an element that is close to an element whose amount of change in the score is significant becomes difficult to be removed, and
the processing circuitry performs filtering according to the adjusted filtering method.

11. The inference apparatus according to claim 8, wherein
the processing circuitry computes the score of each of the plurality of elements,
the processing circuitry adjusts the score by weighing the computed score based on another pierce of information that differs from the score itself, and
the processing circuitry performs filtering based on the adjusted score.

12. The inference apparatus according to claim 8, wherein
the second model is obtained by taking second teaching data that includes the teaching destination data and the teaching source filtering data generated by filtering the plurality of elements included in the teaching source data in first teaching data that includes teaching source data which is source sequence data and the teaching destination data which is destination sequence data, as input.

13. The inference apparatus according to claim 12, wherein
the second model is obtained by setting each of a plurality of percentages as a target percentage, performing filtering to remove from the elements included in the teaching source data, elements that fall within the target parentage, generating the teaching source filtering data corresponding to the target percentage, setting the teaching source filtering data corresponding to each of the plurality of percentages as target teaching source filtering data in ascending order from the lowest percentage, and taking teaching data that includes the target teaching source filtering data and the teaching destination data as input to learn parameters.

14. The inference apparatus according to claim 12, wherein
the second model is obtained by learning parameters to bring a score obtained from a computation result by an attention mechanism in the first model close to a score obtained from a computation result by an attention mechanism in the second model.

15. The inference apparatus according to claim 8, wherein
the processing circuitry, when the input filtering data is longer than a specified length, sets each of a plurality of pieces of split data obtained by splitting the input filtering data as target split data, and filters elements included in the target split data to newly generate split filtering data corresponding to the target split data, and
the processing circuitry merges the newly generated split filtering data to newly generate the input filtering data.

16. A learning method comprising:
computing a score of each of a plurality of elements included in teaching source data in first teaching data that includes the teaching source data which is source sequence data and teaching destination data which is destination sequence data, using an attention mechanism in a first model that infers the destination sequence data from the source sequence data, and filtering the plurality of elements included in the teaching source data based on the score of each of the plurality of elements to generate teaching source filtering data;
learning parameters of a second model that converts the teaching source filtering data to the teaching destination data by taking second teaching data that includes the teaching source filtering data and the teaching destination data as input;
setting each of a plurality of pieces of split data obtained by splitting the teaching source data as target split data, and filtering elements included in the target split data to generate split filtering data corresponding to the target split data; and
merging the split filtering data corresponding to each of the plurality of pieces of split data to generate the teaching source filtering data.

17. A learning method comprising:
computing a score of each of a plurality of elements included in teaching source data in first teaching data that includes the teaching source data which is source sequence data and teaching destination data which is destination sequence data, using an attention mechanism in a first model that infers the destination sequence data from the source sequence data, and filtering the plurality of elements included in the teaching source data based on the score of each of the plurality of elements to generate teaching source filtering data;
learning parameters of a second model that converts the teaching source filtering data to the teaching destination data by taking second teaching data that includes the teaching source filtering data and the teaching destination data as input;
assigning a special token to an element that has been removed through filtering; and
restoring the specified special token back to an original element.

18. A non-transitory computer readable medium storing a learning program for causing a computer to function as a learning apparatus to execute:
a filtering process to compute a score of each of a plurality of elements included in teaching source data in first teaching data that includes the teaching source data which is source sequence data and teaching destination data which is destination sequence data, using an attention mechanism in a first model that infers the destination sequence data from the source sequence data, and to filter the plurality of elements included in the teaching source data based on the score of each of the plurality of elements to generate teaching source filtering data; and
a filtering data learning process to learn parameters of a second model that converts the teaching source filtering data to the teaching destination data by taking second teaching data that includes the teaching source filtering data generated by the filtering process and the teaching destination data as input, wherein
during the filtering process, each of a plurality of pieces of split data obtained by splitting the teaching source data is set as target split data, and elements included in the target split data are filtered to generate split filtering data corresponding to the target split data, and
the learning program further causes the computer to execute
a filtering data merge process to merge the split filtering data corresponding to each of the plurality of pieces of split data to generate the teaching source filtering data.

19. A non-transitory computer readable medium storing a learning program for causing a computer to function as a learning apparatus to execute:
a filtering process to compute a score of each of a plurality of elements included in teaching source data in first teaching data that includes the teaching source data which is source sequence data and teaching destination data which is destination sequence data, using an attention mechanism in a first model that infers the destination sequence data from the source sequence data, and to filter the plurality of elements included in the teaching source data based on the score of each of the plurality of elements to generate teaching source filtering data; and
a filtering data learning process to learn parameters of a second model that converts the teaching source filtering data to the teaching destination data by taking second teaching data that includes the teaching source filtering data generated by the filtering process and the teaching destination data as input, wherein
during the filtering process, a special token is assigned to an element that has been removed through filtering, and
the learning program further causes the computer to execute
a filtering correction process to restore the specified special token back to an original element.

20. An inference method comprising:
computing a score of each of a plurality of elements included in input data which is source sequence data, using an attention mechanism in a first model that infers destination sequence data from source sequence data, and filtering the plurality of elements included in the input data based on the score of each of the plurality of elements to generate input filtering data;
inferring output data from the input filtering data using a second model that infers destination sequence data from source sequence data;
setting each of a plurality of pieces of split data obtained by splitting the input data as target split data, and filtering elements included in the target split data to generate split filtering data corresponding to the target split data, and
merging the split filtering data corresponding to each of the plurality of pieces of split data to generate the input filtering data.

21. An inference method comprising:
computing a score of each of a plurality of elements included in input data which is source sequence data, using an attention mechanism in a first model that infers destination sequence data from source sequence data, and filtering the plurality of elements included in the input data based on the score of each of the plurality of elements to generate input filtering data;
inferring output data from the input filtering data using a second model that infers destination sequence data from source sequence data:
assigning a special token to an element that has been removed through filtering; and
restoring the specified special token back to an original element.

22. A non-transitory computer readable medium storing an inference program for causing a computer to function as an inference apparatus to execute:
a filtering process to compute a score of each of a plurality of elements included in input data which is source sequence data, using an attention mechanism in a first model that infers destination sequence data from source sequence data, and to filter the plurality of elements included in the input data based on the score of each of the plurality of elements to generate input filtering data; and
a filtering data inference process to infer output data from the input filtering data generated by the filtering process using a second model that infers destination sequence data from source sequence data, wherein
during the filtering process, each of a plurality of pieces of split data obtained by splitting the input data is set as target split data, and elements included in the target split data are filtered to generate split filtering data corresponding to the target split data, and
the inference program further causes the computer to execute
a filtering data merge process to merge the split filtering data corresponding to each of the plurality of pieces of split data to generate the input filtering data.

23. A non-transitory computer readable medium storing an inference program for causing a computer to function as an inference apparatus to execute:
a filtering process to compute a score of each of a plurality of elements included in input data which is source sequence data, using an attention mechanism in a first model that infers destination sequence data from source sequence data, and to filter the plurality of elements included in the input data based on the score of each of the plurality of elements to generate input filtering data; and
a filtering data inference process to infer output data from the input filtering data generated by the filtering process using a second model that infers destination sequence data from source sequence data, wherein
during the filtering process, a special token is assigned to an element that has been removed through filtering, and
the inference program further causes the computer to execute
a filtering correction process to restore the specified special token back to an original element.
